(19) United States
(12) Patent Application Publication
(10) Pub. No.: US 2009/0289554 A1
(43) Pub. Date: Nov. 26, 2009

(54) Discharge lamp with ignition assisting element

(75) Inventor: Matthias Morkel, Berlin (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellschaft, Munchen (DE)

(21) Appl. No.: 12/309,154

(22) PCT Filed: Jul. 19, 2007
(86) PCT No.: PCT/EP2007/057458

§ 371 Date: Jan. 8, 2009

(30) Foreign Application Priority Data
Jul. 21, 2006 (DE) 10 2006 033 871.5

(51) Int. Cl. H01J 61/54; H01J 61/56

(52) U.S. Cl. 315/56; 313/594

(57) ABSTRACT

Disclosed is a discharge lamp, in particular a high pressure discharge lamp, with at least one discharge vessel and at least one ignition assisting element, preferably an ignition assisting wire or an electrically conducting coating of the discharge vessel, which element can be electrically connected to a power feed to the discharge lamp and which extends at least in some sections along the discharge vessel, wherein a device is provided for interrupting the electrical connection between at least one partial section of the ignition assisting element and the power feed in the operating state of the discharge lamp. Additionally disclosed are an ignition assisting device and a method for operating a discharge lamp of this kind.

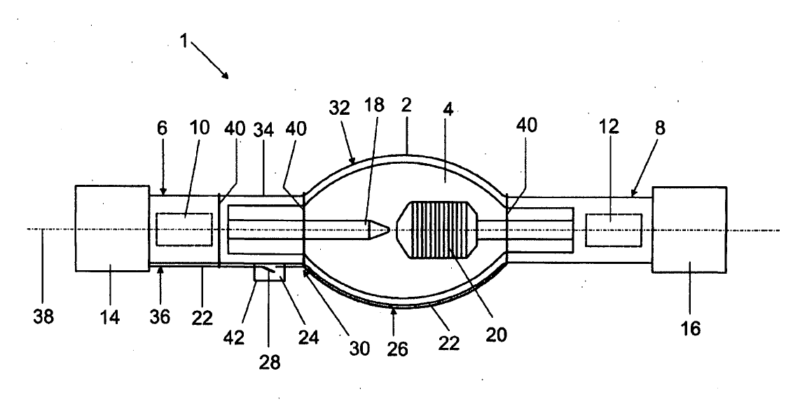

### TECHNICAL FIELD

The invention relates to a discharge lamp, in particular a high-pressure discharge lamp, with at least one discharge vessel and at least one auxiliary ignition element, in particular an auxiliary ignition wire or an electrically conductive coating of the discharge vessel, which can be electrically conductively connected to a power supply line of the discharge lamp and at least sections of which extend along the discharge vessel, and to a method for operating such a discharge lamp. Furthermore, the invention relates to an auxiliary ignition device for such a discharge lamp.

### PRIOR ART

Such a discharge lamp is known, for example, from DE 90 04 811 U1 by the Applicant. These conventional discharge lamps in the form of sodium high-pressure discharge lamps have a discharge vessel made from aluminum oxide ceramic with an interior, into which two diametrically arranged electrodes protrude, with a gas discharge being formed between said electrodes during lamp operation. An ionizable fill is enclosed in the interior of the discharge vessel. The discharge vessel is surrounded by an outer bulb with a tubular construction which has two end sections, which are arranged diametrically with respect to one another and in which in each case one molybdenum foil is embedded, in each case one outer power supply line and one inner power supply line, which is connected to an electrode, being arranged on two opposite narrow sides of the molybdenum foils. In order to improve the ignition properties, such high-pressure discharge lamps are provided with an auxiliary ignition wire (ZHD), which is electrically conductively connected to a power supply line of the discharge lamp and extends along the discharge vessel parallel to a lamp longitudinal axis. As a result of the auxiliary ignition wire, the electrical field between the electrodes is influenced by capacitive coupling in such a way that the ignition of the discharge lamp is facilitated, the electrical flashover by the gas in the fill taking place more rapidly and/or even at a lower voltage than would be the case without the auxiliary ignition element. Since, as a result of the auxiliary ignition wire present at the discharge vessel, electrolysis phenomena can result at the operating temperature of the discharge lamp with increasing operating time and thus there may be a safety risk, the auxiliary ignition wire is connected to the power supply line via a bimetallic strip in this solution, which bimetallic strip is formed such that the auxiliary ignition wire bears against the discharge vessel during coldstarting of the discharge lamp so as to improve the ignition properties and is lifted off completely from the discharge vessel and protrudes therefrom laterally at an angle in the operating state of the lamp as a result of deformation of the bimetallic strip, with the result that direct touching contact between the auxiliary ignition wire and the discharge vessel and therefore electrolysis phenomena are avoided. Disadvantages with such high-pressure discharge lamps are firstly that they are not suitable for an embodiment without an outer bulb since the auxiliary ignition wire protrudes from the discharge lamp at an acute angle in the operating state of said discharge lamp, with the result that contact may undesirably be made with the luminaire, and secondly additional fitting complexity and costs are required in order to attach the bimetallic strip with the auxiliary ignition wire to the discharge vessel and to align it. Furthermore, such solutions have a high space requirement as a result of the auxiliary ignition wire, which protrudes from the discharge vessel in the operating state of the high-pressure discharge lamp and is surrounded by the envelope.

Furthermore, discharge lamps with a discharge vessel made from glass are known from the general prior art. In the case of such lamps, devitrification of the discharge vessel (crystallization of the glass) and as a result a safety risk may arrive at the operating temperature of the discharge lamp as a result of the auxiliary ignition wire which bears against the discharge vessel made from glass.

### DESCRIPTION OF THE INVENTION

The invention is based on the object of providing a discharge lamp, a method for operating a discharge lamp and an auxiliary ignition device which allow for an improved ignition response given good operational properties with minimum complexity in terms of apparatus in comparison with conventional solutions.

This object is achieved by a discharge lamp, in particular a high-pressure discharge lamp, with at least one discharge vessel and at least one auxiliary ignition element, preferably an auxiliary ignition wire or an electrically conductive coating of the discharge vessel, which can be electrically conductively connected to a power supply line of the discharge lamp and at least sections of which extend along the discharge vessel, an apparatus for interrupting the electrical connection between at least one subsection of the auxiliary ignition element and the power supply line in the operating state of the discharge lamp, i.e. after ignition of the discharge lamp, being provided. This object is furthermore achieved by a method for operating a discharge lamp, in which, prior to the ignition of the discharge lamp, the auxiliary ignition element is connected to a power supply line of the discharge lamp by means of an apparatus for interrupting the electrical connection, the electrical connection being interrupted between the at least one subsection of the auxiliary ignition element and the power supply line in the operating state of the discharge lamp by means of the interrupter apparatus. This object is also achieved by an auxiliary ignition device for a discharge lamp with an apparatus for interrupting the electrical connection between at least one subsection of the auxiliary ignition element and a power supply line in the operating state of the discharge lamp.

In the solution according to the invention, during ignition of the cold discharge lamp an electrical connection between the auxiliary ignition element, for example an auxiliary ignition wire, and the power supply line is provided, with the result that the ignition properties are substantially improved by means of capacitive coupling. During the ignition phase and the subsequent startup phase of the discharge lamp, the energy input required for ignition and the transition from glow discharge to arc discharge is minimized with the aid of the auxiliary ignition element. The term startup phase in this case refers to the time span from ignition of the lamp to the time at which a quasi steady-state operating state is reached, in which stable arc discharge has formed in the lamp. In the operating state of the discharge lamp, the connection is opened by the interrupter apparatus, with the result that the auxiliary ignition element is at least partially no longer connected to the power supply line and devitrification and possibly electrolysis phenomena are substantially prevented. This solution has the advantage over the prior art in accordance with DE 90 04 811 U1 that the auxiliary ignition wire is not bent back from the discharge lamp at an acute angle in the operating state of said discharge lamp, but at least sections of it bear against the discharge vessel and it is only electrically decoupled from the power supply line, with the result that the solution according to the invention has an improved starting response given a compact construction. Furthermore, the auxiliary ignition element in the solution according to the invention can be applied to the discharge vessel as an electrically conductive coating in a manner which is advantageous in terms of manufacturing technology.

In accordance with a particularly preferred exemplary embodiment, the apparatus for interrupting the electrical connection is a thermostatic switch (thermostat), which is integrated in the auxiliary ignition element, is thermally conductively connected to the discharge vessel and is closed for ignition of the discharge lamp and opens automatically in the operating state of the lamp as a result of the heating of the discharge vessel and interrupts the electrical connection to at least one subsection of the auxiliary ignition element, with the result that devitrification is substantially prevented. A thermostatic switch which is resistant to high temperatures and has safe operation even at temperatures above approximately 200° C., in particular a reliable closing response in the event of cooling from the hot state, is preferably used.

In a preferred embodiment of the invention, the auxiliary ignition element can be electrically connected to the cathode base sleeve, i.e. to the negative potential of the discharge lamp.

It has proven to be particularly advantageous if the thermostatic switch is arranged in a transition region between a base neck and a bulb section of the discharge vessel on an outer circumferential surface of the base neck, with the result that the auxiliary ignition element is electrically conductively connected to the power supply line in the region of a foil fuse seal arranged in the base neck even when the thermostatic switch is open. In other words, the auxiliary ignition element is always at the negative potential in the region of the foil fuse seal. As a result, instances of the molybdenum foils embedded in sealing fashion in the base necks lifting off from the glass of the discharge vessel as a result of electromigration, i.e. as a result of material transport owing to ion movements in the foils, can be prevented. During ignition of the cold lamp, on the other hand, the entire auxiliary ignition element is connected to the negative potential owing to the fact that the thermostatic switch is closed, and the starting response is correspondingly improved.

In a preferred exemplary embodiment of the invention, the auxiliary ignition wire used as the auxiliary ignition element is matched substantially to the contour of the discharge vessel and at least sections of it bear against the surface thereof. As a result, optimized capacitive coupling between the auxiliary ignition wire and the interior of the discharge lamp is achieved.

Preferably, the auxiliary ignition wire, at least in sections, is curved in arcuate fashion, extends parallel to a lamp longitudinal axis and/or is wrapped around the discharge vessel, at least in sections, in the region of base necks of the discharge lamp and, as a result, is fastened to the discharge vessel in a simple manner in terms of manufacturing technology.

The discharge lamp according to the invention may be in the form of, for example, an HBO® or XBO® high-pressure discharge lamp.

### BRIEF DESCRIPTION OF THE DRAWING

The invention will be explained in more detail below with reference to a preferred exemplary embodiment. The single FIGURE shows a schematic illustration of a discharge lamp according to the invention in the form of a high-pressure discharge lamp.

### PREFERRED EMBODIMENT OF THE INVENTION

The invention will be explained below with reference to an HBO® high-pressure discharge lamp, which is used, for example, in microscopy or plastics technology. The discharge lamp according to the invention is in no way restricted to such lamp types, however.

The single FIGURE shows a schematic illustration of an HBO® high-pressure discharge lamp 1 with a base at two ends using short-arc technology. Said lamp has a discharge vessel 2 made from quartz glass with an interior 4 and two diametrically arranged, sealed base necks 6, 8, which each have a power supply line (not illustrated) with a schematically indicated molybdenum foil fuse seal 10, 12 and are provided with a base sleeve 14, 16. Two diametrically arranged electrodes 18, 20, which are each connected to one of the power supply lines and between which a gas discharge is formed during lamp operation, protrude into the interior 4. For this purpose, an ionizable fill is enclosed in the interior 4 of the discharge vessel 2, which ionizable fill substantially comprises one or more noble gases and a small quantity of mercury. The left-hand electrode 18 in the FIGURE is in the form of a conical top cathode so as to generate high temperatures, in order to ensure a defined arc attachment and sufficient electron flux owing to thermal emission and field emission (Richardson equation). The right-hand electrode 20 is in the form of a barrel-shaped top anode which is subjected to a high thermal load, in the case of which the emission power is improved by sufficient dimensioning of the electrode size. At the base end, the electrodes 18, 20 are connected to the supply voltage via base pins or litz wires (not illustrated).

In order to improve the ignition properties, the high-pressure discharge lamp 1 is provided with an auxiliary ignition element in the form of an auxiliary ignition wire 22, which is electrically conductively connected to a power supply line of the discharge lamp 1 via the base sleeve 14 and sections of which extend along the discharge vessel 2, an apparatus 24 for interrupting the electrical connection between a subsection 26 of the auxiliary ignition wire 22 and the power supply line in the operating state of the discharge lamp 1, i.e. after ignition of the discharge lamp 1, being provided. In accordance with the exemplary embodiment illustrated, the apparatus 24 for interrupting the electrical connection is a thermostatic switch 24, which is integrated in the auxiliary ignition wire 22, with a bimetallic element 28, which is arranged in a housing 42 and is thermally conductively connected to the discharge vessel 2 and is closed for ignition of the discharge lamp 1 and opens automatically in the operating state of the lamp 1 shown in the FIGURE as a result of the heating of the discharge vessel 2 and interrupts the electrical connection to the subsection 26 of the auxiliary ignition wire 24, with the result that devitrification of the discharge vessel 2 with increasing operating time of the discharge lamp 1 is prevented. In other words, during ignition of the cold discharge lamp 1, an electrical connection between the entire auxiliary ignition wire 24 and the power supply line is provided, with the result that the ignition properties are substantially improved by capacitive coupling. The thermostatic switch 24 allows for decoupling of the subsection 26 of the auxiliary ignition wire 24 from the load circuit, with the result that, once the lamp has been ignited, the subsection 26 is substantially potential-free. During the ignition phase and the subsequent startup phase of the discharge lamp 1, the energy input required for the ignition and the transition from the glow discharge to the arc discharge is minimized with the aid of the auxiliary ignition wire 22. The term startup phase in this case denotes the time span from the ignition of the lamp 1 up to the time at which a quasi steady-state operating state is reached, in which a stable arc discharge has formed in the discharge lamp 1. In the operating state of the discharge lamp 1 illustrated, the electrical connection is opened by the thermostatic switch 24, with the result that the subsection 26 of the auxiliary ignition wire 22 is no longer connected to the power supply line. In the embodiment of the invention illustrated, the auxiliary ignition wire 22 is electrically connected to the cathode base sleeve 14, i.e. to the negative potential of the discharge lamp 1. It has proven to be particularly advantageous in this case if the thermostatic switch 24 is arranged in a transition region 30 between the cathode-side base neck 6 and a bulb section 32 of the discharge vessel 2 on an outer circumferential surface 34 of the base neck 6, with the result that a section 36 of the auxiliary ignition wire 22 is electrically conductively connected to the power supply line, i.e. is always at the negative potential, in the region of the foil fuse seal 10 even when the thermostatic switch 24 is open. As a result, instances of the foils being lifted off as a result of electromigration can be prevented. During ignition of the cold lamp 1, on the other hand, the entire auxiliary ignition wire 22 is connected to the negative potential owing to the fact that the thermostatic switch 24 is closed. The auxiliary ignition wire 22 used as the auxiliary ignition element is matched substantially to the contour of the discharge vessel 2 and sections of it bear against said discharge vessel. As a result, optimized capacitive coupling between the auxiliary ignition wire 22 and the discharge lamp 2 is achieved. In accordance with the FIGURE, the auxiliary ignition wire 22 extends, in sections, in such a way that it is curved in arcuate fashion and parallel to a lamp longitudinal axis 38 and is wrapped around the discharge vessel 2 in each case in the region of the base necks 6, 8, with the result that holding lugs 40 are formed, via which the auxiliary ignition wire 22 and the thermostatic switch 24 are fastened to the discharge vessel 2 in a manner which is simple in terms of manufacturing technology, with two holding lugs 40, which engage around the cathode-side base neck 6, being formed adjacent to the thermostatic switch 24.

In one variant of the invention (not illustrated), the auxiliary ignition element 22 is applied to the discharge vessel 2 in the form of an electrically conductive coating.

The discharge lamp 1 according to the invention is not restricted to the exemplary embodiment illustrated, but instead the discharge lamp 1 can have different discharge vessel forms known from the prior art and/or be implemented using rod fuse-sealing technology. Furthermore, the discharge lamp 1 according to the invention can be in the form of a high-wattage XBO® high-pressure discharge lamp.

The invention discloses a discharge lamp 1, in particular a high-pressure discharge lamp, with at least one discharge vessel 2 and at least one auxiliary ignition element 22, preferably an auxiliary ignition wire or an electrically conductive coating of the discharge vessel, which can be electrically conductively connected to a power supply line of the discharge lamp 1 and at least sections of which extend along the discharge vessel 2, an apparatus 24 for interrupting the electrical connection between at least one subsection 26 of the auxiliary ignition element 22 and the power supply line in the operating state of the discharge lamp 1 being provided. Furthermore, the invention discloses an auxiliary ignition device and a method for operating such a discharge lamp 1.

1. A discharge lamp, in particular a high-pressure discharge lamp, with at least one discharge vessel (2) and at least one auxiliary ignition element (22), preferably an auxiliary ignition wire or an electrically conductive coating of the discharge vessel (2), which can be electrically conductively connected to a power supply line of the discharge lamp (1) and at least sections of which extend along the discharge vessel (2), characterized by an apparatus (24) for interrupting the electrical connection between at least one subsection (26) of the auxiliary ignition element (22) and the power supply line in the operating state of the discharge lamp (1).

2. The discharge lamp as claimed in claim 1, the apparatus for interrupting the electrical connection being a thermostatic switch (24), which is thermally conductively connected to the discharge vessel (2) and is closed for ignition of the discharge lamp (1) and is open in the operating state of the lamp (1).

3. The discharge lamp as claimed in claim 2, a thermostatic switch (24) which is resistant to high temperatures and has safe operation even at temperatures above approximately 200° C., in particular a reliable closing response in the event of cooling from the hot state, being used.

4. The discharge lamp as claimed in claim 3, the thermostatic switch (24) being arranged in a transition region (30) between a base neck (6) and a bulb section (32) of the discharge vessel (2) on the base neck (6), with the result that the auxiliary ignition element (22) is electrically conductively connected to one of the power supply lines in the region of a foil fuse seal (10) arranged in the base neck (6) even when the thermostatic switch (24) is open.

5. The discharge lamp as claimed in claim 1, the auxiliary ignition element (22) being capable of being connected to a cathode base sleeve (14), i.e. to the negative potential of the discharge lamp (1).

6. The discharge lamp as claimed in claim 1, the auxiliary ignition wire (22) being matched substantially to the contour of the discharge vessel (2) and at least sections of said auxiliary ignition wire bearing against said discharge vessel.

7. The discharge lamp as claimed in claim 1, the auxiliary ignition wire (22), at least in sections, being curved in arcuate fashion, extending parallel to a lamp longitudinal axis (38) and/or being wrapped around the discharge vessel (2), at least in sections, in the region of base necks (6, 8).

8. The discharge lamp as claimed in claim 1, the lamp (1) being an HBO® or XBO® high-pressure discharge lamp.

9. A method for operating a discharge lamp (1), in particular a high-pressure discharge lamp, with at least one discharge vessel (2) and at least one auxiliary ignition element (22), in particular an auxiliary ignition wire or an electrically conductive coating of the discharge vessel (2), which can be electrically conductively connected to a power supply line of the discharge lamp (1) and at least sections of which extend along the discharge vessel (2), having the following steps:
a) connection of the auxiliary ignition element (22) to the power supply line by means of an apparatus (24) for interrupting the electrical connection;
b) ignition of the discharge in the discharge lamp (1), and
c) interruption of the electrical connection between at least one subsection (26) of the auxiliary ignition element (22) and the power supply line by means of the interrupter apparatus (24) in the operating state of the discharge lamp (1).

10. The method as claimed in claim 9, the electrical connection being produced and interrupted by a thermostatic switch (24).

11. An auxiliary ignition device for a discharge lamp (1), in particular for a high-pressure discharge lamp, with an auxiliary ignition element (22), in particular an auxiliary ignition wire or an electrically conductive coating, at least sections of which extend along a discharge vessel (2), an apparatus (24) for interrupting the electrical connection between at least one subsection (26) of the auxiliary ignition element (22) and a power supply line in the operating state of the discharge lamp (1) being provided.

12. The auxiliary ignition device as claimed in claim 11, the apparatus for interrupting the electrical connection being a thermostatic switch (24).

13. The discharge lamp as claimed in claim 2, the thermostatic switch (24) being arranged in a transition region (30) between a base neck (6) and a bulb section (32) of the discharge vessel (2) on the base neck (6), with the result that the auxiliary ignition element (22) is electrically conductively connected to one of the power supply lines in the region of a foil fuse seal (10) arranged in the base neck (6) even when the thermostatic switch (24) is open.
